(19) United States
(12) Patent Application Publication
(10) Pub. No.: US 2013/0008674 A1
(43) Pub. Date: Jan. 10, 2013

(54) PEANUT PLANT UPROOTER

(75) Inventors: Yösi Kashti, Rishon Lezion (IL); Izhak Sagi, Moshav Bitzaron (IL); Farhad Geoola, Rishon Lezion (IL); Roman Brikman, Raananna (IL); Asher Levi, Ashdod (IL)

(73) Assignee: The State of Israel, Ministry of Agriculture & Rur, Beit Dagan (IL)

(21) Appl. No.: 13/579,287

(22) PCT Filed: Feb. 8, 2011
(86) PCT No.: PCT/IL11/00134

§ 371 Date: Sep. 27, 2012

Related U.S. Application Data
(60) Provisional application No. 61/305,406, filed on Feb. 17, 2010.

(51) Int. Cl. A01D 29/00

(52) U.S. Cl. 171/1; 171/62

(57) ABSTRACT

A peanut plant uprooter which enables uprooting peanut plants from the ground without subjecting them to any pulling forces, shaking, them for the purpose of removing dirt placing them back down on the ground, and arranging them in a continuous window with the foliage covering the peanuts. The peanut plant uprooter penetrates the ground underneath the peanuts by means of two square rotating bars, and lifts the plants by means of a digging conveyor. The plants and soil are conveyed from the digging conveyor to a double-inclined conveyor. The plants are cleaned of dirt by shaking with an active shaking device. The plants are them lowered from the rear to the ground and are placed in windows with the peanuts on the ground and the foliage covering the peanuts.

### REFERENCE TO CROSS-RELATED APPLICATION

This application claims priority from U.S. Provisional Application No. 61/305,406, filed on Feb. 17, 2010, herein incorporated by reference in its entirety.

### FIELD OF THE INVENTION

The present invention relates to root crop harvesting and more particularly to a peanut plant uprooter.

### BACKGROUND OF THE INVENTION

Agriculturists around the world customarily grow peanut plants in elevated beds, with two or three rows of plants per bed. The peanut plant is a sprawling plant, during their growth, the stems of adjacent plants become entwined and form a layer of vegetation. The fruits of the plant grow in the ground, at a depth of approximately 15 cm. When growth is completed, agriculturists customarily uproot the plants and place them to dry in the sun in a windrow on the ground. After drying, they are threshed by a peanut threshing machine, and the peanut harvest is collected.

There are several methods for uprooting peanuts. All common methods involve penetrating the ground under the peanuts using a plowshare, or using rotating bars to uproot the plants. The uprooting, in common methods, involves pulling the plant foliage with a bar conveyor with grooves, or with either a pair of straps or a pair of chains. The pulling action results in the loss of many peanut fruits, which remain under the ground. The plants are removed from the grooved bars with a separating mechanism, and are lowered to the ground.

In one prior art uprooter, of Israeli manufacture, the peanut plants fall off freely from a conveyor with grooves, by falling freely onto side cards.

Construction of the windrow on the ground for the purpose of drying involves dropping the plants from a high height onto various objects, creating windrows which are either not organized, or organized such that the peanuts pods are on top, or on the ground, or in “sandwich” style with the peanuts between the plants. Note that this “sandwich” style is suitable only for growing two rows of plants.

In most of these windrows, many plants are separated from each other, resulting in the loss of peanuts pods. In addition, the separation of the plants increases the difficulty in operating the lifting mechanism of the threshing machine.

In most cases, the windrows are not organized, not continuous, their widths are not uniform, and some of the plants are effectively lying upon the edges of the beds or in the furrows. Furthermore, some of the plants in the windrows are placed either partially or fully overturned, thus exposing the peanuts to solar radiation and precipitation. Solar radiation causes discoloration in the peanuts pods, while precipitation causes development of fungi, which blackens them.

The need for solving the aforementioned problems, and particularly the loss of peanuts as a result of pulling the plants during uprooting, the damage in quality as a result of solar radiation and precipitation, the loss of plants and pods left in furrows, and a decrease in output of threshing machines due to stoppage, have resulted in the development of a method for uprooting and construction of windrows by means of a new machine, according to the present invention.

A Multiple row harvester for peanut crops is described in U.S. Pat. No. 4,257,486 of Hobbs, which is incorporated by reference for all purposes as if fully set forth herein. Hobbs describes a harvester for plowing four rows of root plants, and depositing them in a turned position on the ground as two windrows. The harvester according to Hobbs includes two sets of plow-shares attached to a frame, wherein the frame has wheels, with each plow-share adapted to remove a ribbon of plants; a rotary coulter wheel positioned between the two sets of plow-shares for cutting overlapping vines; two parallel conveyors; spaced projection means adapted to pull uprooted foliage and vines onto the conveyors; means for cutting foliage and vines; and means for turning the ribbons of plants dropped from the upper end of each conveyor, with the ribbons of plants deposited in a single windrow.

Each of the conveyors includes multiple carrying bars and each of the carrying bars is provided with a set of spaced tines which are projected outwardly from the outer face of each of the carrying bars and act as catching fingers that apply pulling forces on the foliage and root network of the peanut-laden plants. This machine, when operated, generates passive vibration of the conveyors for the purpose of separation of peanut plants from the soil.

FIG. 1a of the prior art is a side view schematic illustration of a Hobbs peanut plant harvesting apparatus 10. The illustration also shows one of the four plows 11, one of the two conveyors 12, and several conveyor cleats 12b.

Furthermore, the illustration shows one of the two main wheels 14, a coulter wheel 15, and several curved splines 16, which facilitate the separation of the peanut plants from the conveyor cleats 12b.

FIG. 1b of the prior art is a front view schematic illustration of a Hobbs peanut plant harvesting apparatus 10. The present illustration also shows several conveyor bars 12a.

The Hobbs peanut plant harvesting apparatus 10 is a sort of cross of two machines, each of which has one conveyor 12 and two plows 11. This arrangement is suitable for uprooting peanut plants that are arranged in two rows along each elevated bed. In the case that there are three rows of peanut plants planted in the bed, the machine is not effective. As shown in FIGS. 1a and 1b, the lowest point of each of both conveyors 12 is higher than the highest point of each one of the four plows 11.

The conceptual structure of the machine, its mode of operation, and the pulling force applied to the plant by the two conveyor bars 12a, result in a large quantity of peanuts pod remaining in the ground, while yet another large quantity falls off of the conveyors 12, during the separation of the peanut plants from the conveyor cleats, and peanut plants are placed in windrows facing upwards.

In light of the disadvantages of presently used machines for uprooting peanut plants, there is a need for a machine that can uproot peanut plants from two or three rows with higher efficiency and less loss, and can place the peanut plants on the ground in well-organized form for the following stage of threshing and collection with as little damage sustained from environmental conditions as possible.

### SUMMARY OF THE INVENTION

According to the present invention, peanut plants are uprooted from the ground without being subjected to pulling forces, are shaken for removal of dirt, lowered back to the ground from a low height with their stems still entwined, and organized in a continuous windrow of a uniform width, with the foliage covering the peanuts.

The machine, by means of which the method is implemented, penetrates the ground, underneath the peanuts by means of two square rotating bars, and lifts the layer of plants from underneath with the soil by means of a digging conveyor with thin and densely placed bars. The plants and soil are conveyed from the digging conveyor to a double-inclined conveyor made of smooth, groove-less square steel bars. The plants are cleaned of dirt by shaking with an active shaking device, during their motion on the double-inclined conveyor. The plants received on the front of the conveyor as a uniform and continuous layer are then lowered from its rear to the ground, from a very low height, and are placed in windrows with the peanuts on the ground and the foliage covering the peanuts. When the plants are on the ground, placed in a windrow like a green layer separated from the ground, they are processed through a pair of perpendicular cylinders with a system for weight reduction and the space between the plants is reduced to fix the width of the windrow.

After the complete operation process of the machine and the drying period, the peanuts are ready for threshing and collection.

According to the teaching of the present invention there is provided a peanut plant uprooter (100), for uprooting peanut plants, including: (a) a chassis (95); (b) a frontal digging bar (41) positioned on said chassis (95); (c) a rear digging bar (42) positioned on said chassis (95) behind said frontal digging bar (41); (d) a digging conveyor (43) positioned on said chassis (95) behind said rear digging bar (42); (e) a double-inclined bars conveyor (56) positioned on said chassis (95) behind said digging conveyor (43); (f) two parallelograms (70) positioned on the rear part of said chassis (95); (g) two cylinders (60) positioned below said two parallelograms (70), each one of said cylinders (60) below a different one of said parallelograms (70); (h) a frontal digging bar transmission chain (38), operatively connected to the digging conveyor (43), for transmitting rotational movement from a tractor's propulsion mechanism to the digging conveyor (43); (i) a double-inclined bars conveyor motor (54); (j) a double-inclined bar conveyor transmission chain (59), operatively connected to the double-inclined bars conveyor motor (54), and to the double-inclined bars conveyor (56), for rotating the double-inclined bars conveyor (56), wherein the double-inclined bars conveyor (56) includes: (i) at least two double-inclined bar conveyor bands (57); and (ii) double-inclined conveyor bars (58), wherein each one of the double-inclined conveyor bars (58) is connected to at least two of the double-inclined bar conveyor bands (57), wherein the digging conveyor (43) includes: (i) at least two digging conveyor bands (46); and (ii) digging conveyor bars (47), wherein each one of the conveyor bars (47) is connected to at least two of the digging conveyor bands (46), wherein the chassis (95) includes: (i) a chassis left wall (95r); (ii) a chassis right wall (95l); and (iii) at least one lateral beam (95b) connected to the chassis left wall (95r) and to the chassis right wall (95r); (k) an active shaking mechanism (90) for vibrating the double-inclined bar conveyor (56), connected to the chassis (95), wherein the active shaking mechanism (90) includes: (i) an active shaking mechanism shaft (93); (ii) at least one active shaking mechanism arm (92), connected to the active shaking mechanism shaft (93); (iii) at least one active shaking mechanism wheel (94), installed on the at least one active shaking mechanism arm (92); and (iv) an active shaking mechanism motor (91), wherein the active shaking mechanism motor (91) is operatively connected to the chassis (95); (1) two drive boxes (51) attached on a front side of the chassis (95); (m) two shoes (52) wherein each one of the two shoes (52) is disposed on different one of the drive box (51); (n) two tilling chisels (53) each one is disposed on different one of the shoes (52); (o) a depth control system (80) for controlling a digging depth, wherein the depth control system is positioned on a front side of the peanut plant uprooter (100), wherein the depth control system (80) includes: (i) a depth control system wheel (81); and (ii) a screw jack (82) operatively connected to the depth control system wheel; (p) two roller beams (49) operatively connected to a bottom side of the chassis (95); (q) a roller (48) mounted between the two roller beams (49), for slightly compressing the ground and flattening its surface before peanut plants descend upon it; (r) at least one support leg (97) for supporting the peanut plant uprooter (100) when the peanut plant uprooter (100) is in a storage state, the at least one support leg (97) is mounted to a bottom side of the peanut plant uprooter (100); (s) a digging conveyor hydraulic motor (44) for propulsion of the digging conveyor (43), the digging conveyor hydraulic motor (44) is disposed on the chassis (95); (t) a digging conveyor transmission chain (45) operatively connected to the digging conveyor hydraulic motor (44) and to the digging conveyor (43); (u) a cog wheel (83); (v) a revolutions gauge (84); (x) a tachometer (85), wherein the cog-wheel (83), and the revolutions gauge (84) are positioned on the chassis (95) for measuring motion speed of the double-inclined conveyor bars (58), wherein the tachometer (85) is mounted in a tractor cabin for displaying a speed of the conveyor bars (58) to an operator; (y) a flow control valve (86) operatively connected to the digging conveyor hydraulic motor (44) and to the double-inclined bars conveyor motor (54) with a relief valve (87) for conveyors speed control; and (z) a closed hydraulic system (74) for controlling forces that the cylinders (60) applies on the ground, wherein the closed hydraulic system (74) includes: (i) an accumulator (75); and (ii) two bidirectional hydraulic cylinders (76), operatively connected to the accumulator (75), wherein each one of the two parallelograms (70) includes: (i) a parallelogram upper beam (73); and (ii) a parallelogram rear beam (72), operatively connected to the parallelogram upper beam (73), wherein each one of the cylinders (60) is mounted to a different one of the two parallelograms (70), and wherein each one of the two bidirectional hydraulic cylinders (76), is operatively connected to a different one of the two parallelograms (70), wherein in operation of uprooting peanut plant, the peanut plant uprooter (100) is harnessed to a tractor, wherein each one of the double-inclined conveyor bars (58), moves in a cyclic motion, wherein in part of the cyclic motion each one of the double-inclined conveyor bars (58), moves backward relative to the chassis (95) in an upward angle relative to the ground and after that in a downward angle relative to the ground at a predetermined speed relative to the ground.

According to the teaching of the present invention there is provided a method for peanut plant uprooting including the stages of: (a) driving a peanut plant uprooter (100), by a tractor, over a peanut field, wherein the peanut plant uprooter (100) includes: (i) a chassis (95); (ii) a frontal digging bar (41) positioned on the chassis (95); (iii) a rear digging bar (42) positioned on the chassis (95) behind the frontal digging bar (41); (iv) a digging conveyor (43) positioned on the chassis (95) behind the rear digging bar (42); (v) a double-inclined bars conveyor (56) positioned on the chassis (95) behind the digging conveyor (43); (vi) two parallelograms (70) positioned on a rear part of the chassis (95); and (vii) two cylinders (60) positioned below the two parallelograms (70), each one of the cylinders (60) below different one of the parallelograms (70); (vii) a frontal digging bar transmission chain (38), operatively connected to the digging conveyor (43), for transmitting rotational movement from a tractor's propulsion mechanism to the digging conveyor (43); (viii) a double-inclined bars conveyor motor (54); (ix) a double-inclined bar conveyor transmission chain (59), operatively connected to the double-inclined bars conveyor motor (54), and to the double-inclined bars conveyor (56), wherein the double-inclined conveyor includes: (i) at least two double-inclined bar conveyor bands (57), and (ii) double-inclined conveyor bars (58), wherein each one of the double-inclined conveyor bars (58) is connected to at least two of the double-inclined bar conveyor bands (57); (x) a digging conveyor hydraulic motor (44); (xii) a digging conveyor transmission chain (45), operatively connected to the digging conveyor hydraulic motor (44), and to the digging conveyor (43),_wherein the digging conveyor (43) includes: (xa) at least two digging conveyor band (46); and (xb) digging conveyor bars (47), wherein each of the conveyor bars (47) is connected to at least two of the digging conveyor band (46); (xi) an active shaking mechanism (90) for vibrating the double-inclined bar conveyor (56), connected to the chassis (95); (xii) a depth control system (80) for controlling a digging depth, wherein the depth control system is positioned in a front side of the peanut plant uprooter (100); and (xiii) a roller (48) operatively connected to a bottom side of the peanut plant uprooter (100); (b) inserting the frontal digging bar (41) and the rear digging bar (42) into the ground; (c) controlling depth, by the depth control system (80), one of the digging conveyor bars (47), of the digging conveyor (43), which is at a given time the lowest among the digging conveyor bars (47) at a predetermined depth within the ground; (d) conveying peanut plants on the double-inclined bars conveyor (56) and shaking the double-inclined bars conveyor (56) by an active shaking mechanism (90); (e) compressing the ground and flattening its surface, by the roller (48); (f) lowering the peanut plants behind the peanut plant uprooter (100) onto the ground at an orientation wherein the peanut plants leafs are above the peanut plants pods; and (g) arranging, by the rotating cylinders (60), the lowered peanut plants on the ground in a windrow with a predetermined width.

Additional objects and advantages of the invention will be set forth in part in the description which follows and, in part, will be obvious from the description, or may be learned by practice of the invention.

### BRIEF DESCRIPTION OF THE DRAWINGS

The invention is herein described, by way of example only, with reference to the accompanying drawings, wherein:

FIG. 1a of the prior art is a side view schematic illustration of a Hobbs peanut plant harvesting apparatus.

FIG. 1b of the prior art is a front view schematic illustration of a Hobbs peanut plant harvesting apparatus.

FIG. 2 is an isometric rear view schematic illustration of a tractor pulling a peanut plant uprooter during its operation, according to the present invention, upon which the section plane a-a is marked.

FIG. 3 is an isometric rear view schematic illustration of the two cylinders of the peanut plant uprooter according to the present invention, and a cross sectional view a-a in the ground.

FIG. 4 is an isometric view schematic illustration of a peanut plant uprooter according to the present invention.

FIG. 5 is a right side view schematic illustration of the peanut plant uprooter, according to the present invention.

FIG. 6 is a left side view schematic illustration of the peanut plant uprooter, according to the present invention.

FIG. 7 is an isometric view schematic illustration of the chassis of the peanut plant uprooter, according to the present invention.

FIG. 8 is an isometric view schematic illustration of conveyor bars of the peanut plant uprooter, according to the present invention.

FIG. 9 is an isometric view schematic illustration of an active shaking system, of the peanut plant uprooter, according to the present invention.

FIG. 10 is an isometric view schematic illustration of a depth control system, of the peanut plant uprooter, according to the present invention.

FIG. 11a is a left side view schematic illustration of a peanut plant uprooter, equipped with a cog wheel, and a revolutions gauge, according to an embodiment of the present invention.

FIG. 11b is an isometric view schematic illustration of a cog-wheel, and a revolutions gauge, according to an embodiment of the present invention.

FIG. 12 is a schematic view of a conveyor speed control loop, according to the present invention.

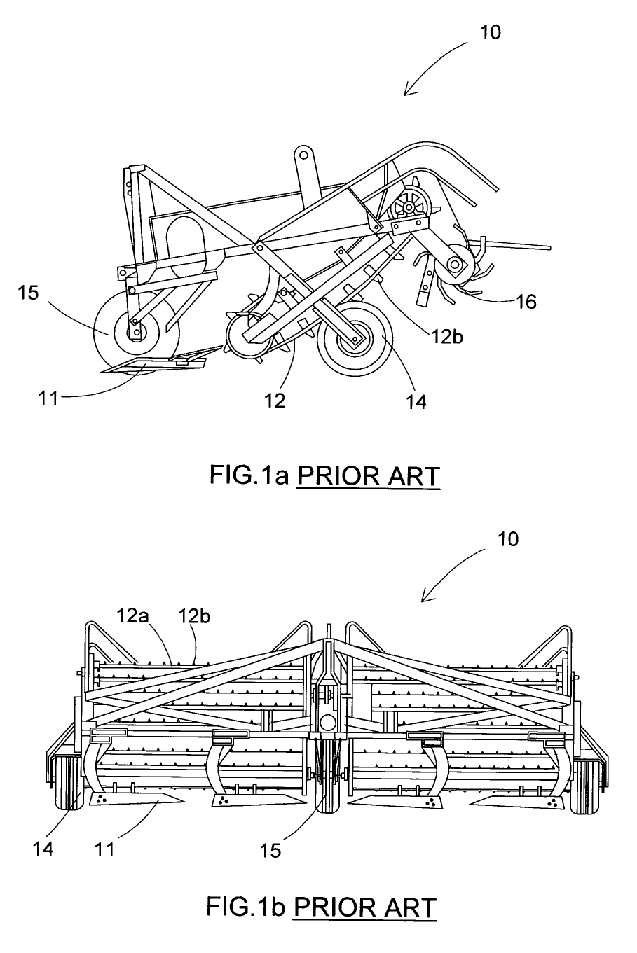

In order to remove any doubt, the elements shown in the illustrations of the present patent application in a manner that enables understanding them clearly, and the scales, size relations, and shapes are not in any way limiting them. Likewise, it is noted that reference numerals may be repeated among the figures to indicate corresponding or analogous elements.

### DETAILED DESCRIPTION OF EMBODIMENTS

To remove any doubt, note that the manner in which the elements of the present invention are described in the illustrations can be highly detailed, however is not in any way limiting the present illustration; however it is for the purpose of clarification and furthering understanding. The present invention can be implemented in embodiments that differ from the specification given with regard to the illustration.

The present invention is of a root crop harvesting device and more particularly to a peanut plant uprooter.

The principles and operation of a peanut plant uprooter according to the present invention may be better understood with reference to the drawings and the accompanying description.

Before explaining at least one embodiment of the invention in detail, it is to be understood that the invention is not limited in its application to the details of construction and the arrangement of the components set forth in the following description or illustrated in the drawings.

Unless otherwise defined, all technical and scientific terms used herein have the same meaning as commonly understood by one of ordinary skill in the art to which this invention belongs. The materials, dimensions, methods, and examples provided herein are illustrative only and are not intended to be limiting.

The following list is a legend of the numbering of the application illustrations:

10 Hobbs peanut plant harvesting apparatus

11 plow

12 conveyors

12a conveyors bar

12b conveyors cleat

14 main wheel

15 coulter wheel

16 curved splines

20 tractor

30 peanut plants

32 peanut windrow

38 frontal digging bar transmission chain

39 rear digging bar transmission chain

41 frontal digging bar

42 rear digging bar

43 digging conveyor

44 digging conveyor hydraulic motor

45 digging conveyor transmission chain

46 digging conveyor band

47 digging conveyor bar

48 roller

49 roller beam

50 hanging means

51 drive box

52 shoe

53 tilling chisel (steel)

54 double-inclined bars conveyor motor

55 double-inclined bars conveyor motion axle

56 double-inclined bars conveyor

57 double-inclined bar conveyor band

58 double-inclined conveyor bar

59 double-inclined conveyor bar transmission chain

60 cylinder

61 cylinder shaft

62 concave bottom lid

63 clutch

70 parallelogram

71 parallelogram axis

72 parallelogram rear beam

73 parallelogram upper beam

74 closed hydraulic system

75 accumulator

76 bidirectional hydraulic cylinder

80 depth control system

81 depth control system wheel

82 jack screw

83 cog wheel

84 revolutions gauge

85 tachometer

86 flow control valve

87 relief valve

88P hydraulic pressure line

88T hydraulic return line

89 conveyors speed control loop

90 active shaking mechanism

91 active shaking mechanism motor

92 active shaking mechanism arm

93 active shaking mechanism shaft

94 active shaking mechanism wheel

95 chassis

95b lateral beam

95l chassis left wall

95r chassis right wall

96 harnessing point

97 support leg

97a tuning hole

97b locking pin

100 peanut plant uprooter

d₁ gap between both cylinders

d₂ gap between the ends of the ditches in which the tractors wheels roll

As used herein in the specification and in the claims section that follows, the term “bar” is specifically meant to encompass all cross-sectional profiles thereof, including, but not limited to, triangular profiles, quadrangle profiles, rectangular profiles, pentagonal profiles, hexagonal profiles, octagonal profiles, circular profiles, oval profiles, and irregular profiles.

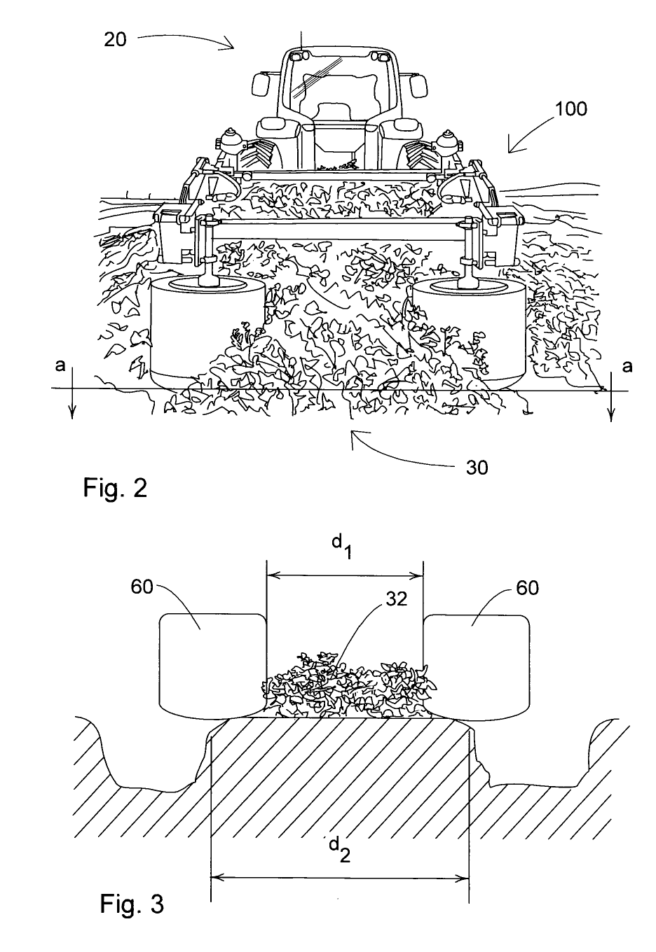

Referring now to the drawings, FIG. 2 is an isometric rear view schematic illustration of a tractor 20 pulling a peanut plant uprooter 100 during operation, according to the present invention, upon which the section plane a-a is marked.

The side of the peanut plant uprooter 100 facing the tractor, which is its direction of motion during operation, will be hereinafter referred to as its front, thus also defining its right and left sides and its rear.

FIG. 3 is an isometric rear view schematic illustration of the two cylinders 47 of the peanut plant uprooter according to the present invention, and a cross sectional view a-a in the ground.

Between both cylinders 47 is a gap d₁ which is smaller than the gap d₂ between the ends of the ditches in which the tractors wheels roll. This determines the width of the peanut windrow 32 which is created as a result of the operation of the peanut plant uprooter.

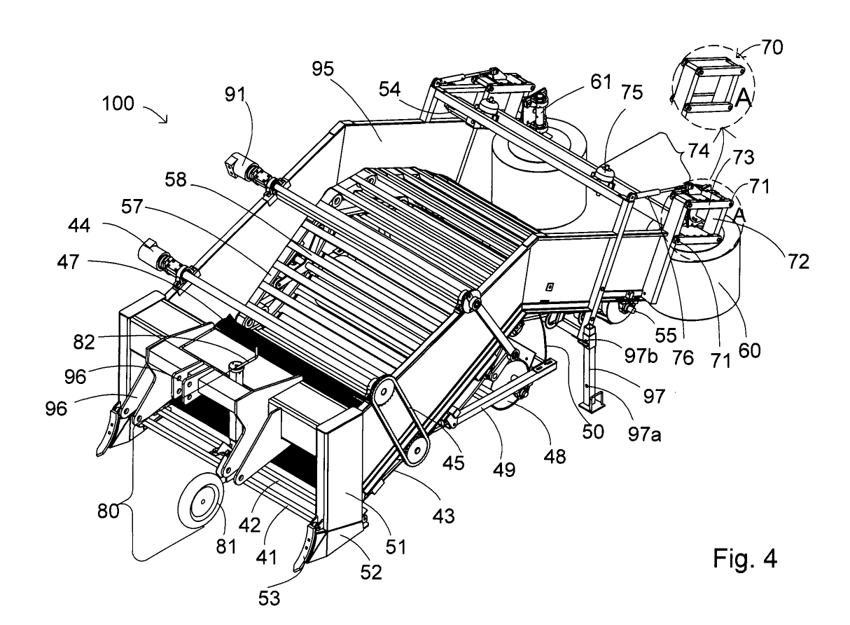

FIG. 4 is an isometric view schematic illustration of a peanut plant uprooter 100, according to the present invention.

The peanut plant uprooter 100 is a machine which is pulled by a tractor 20 (not shown in FIG. 4, shown in FIG. 2), and some of whose assemblies will be described in the following, are driven from the tractor's power take off drive (PTO), via a shaft to gearbox input shaft.

This description is, however, in no way limiting the present invention to any specific form of operation, and the machine according to the present invention can also have independent drive, or be engaged with a larger machine.

The peanut plant uprooter 100 according to the present invention uproots peanut plants from the ground without subjecting them to any pulling forces, shakes them for the purpose of cleaning them from dirt, lowers them back to the ground from a low height, such as 30 to 40 cm, with their stems still entwined, and arranges them in a continuous windrow of a uniform width, with the foliage covering the peanuts.

The present configuration of the peanut plant uprooter 100 is shown in a specific exemplary embodiment with dimensions and shapes of various components, and also with specific angles and materials, all of which are given as examples for actual effective operation, however are in no way to limit the present invention, and peanut plant uprooter 100 according to the present invention can be manufactured in a variety of dimensions and using a variety of suitable materials.

The peanut plant uprooter 100 according to the present invention, in the present embodiment, is operated by a tractor 20 (not shown in FIG. 4, shown in FIG. 2), which is harnessed at three points linkage.

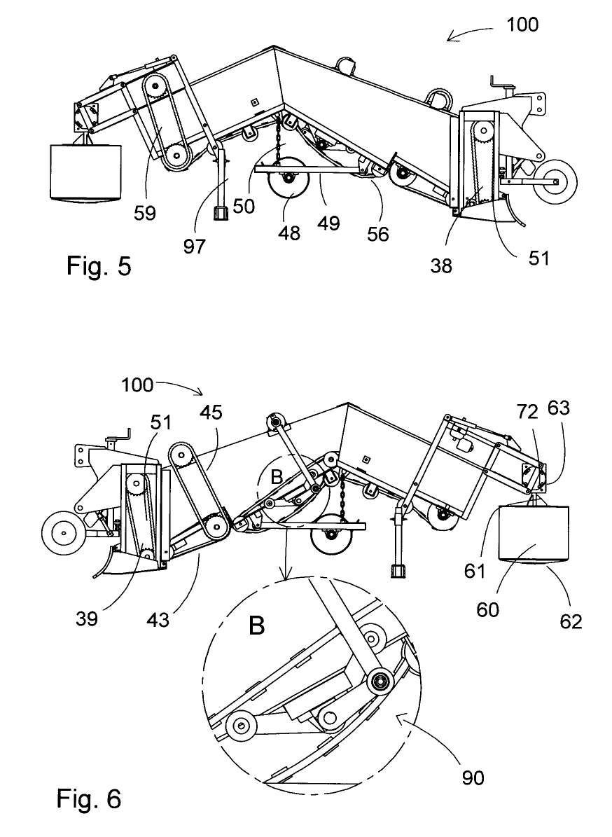

The peanut plant uprooter 100 has bars, frontal digging bar 41 and rear digging bar 42, each of which has a cross section which can be square shaped, and which are located one after the other, with the rear digging bar 42 located slightly higher than the frontal digging bar 41, relative to ground level. The digging bars are driven and rotate in rotational movement around their longitudinal axes, from the tractor's propulsion mechanism through a gear, not shown in the illustrations, and chain transmissions, frontal digging bar transmission chain 38 (not shown in FIG. 4, shown in FIG. 5), and rear digging bar transmission chain 39 (not shown in FIG. 4, shown in FIG. 6), which are fixed in a drive box 51.

When the peanut plant uprooter 100 is operated, the digging rods 41 and 42 penetrate the ground underneath the peanuts, uproot the plants and lift them. The bottoms of the drive boxes 51 penetrate the ground. The bottoms of the drive boxes 51 have mounted shoes 52 with tilling chisels 53, which are made of suitable material such as steel which is resistant to wear, in order to facilitate their penetration into the ground. The shoes 52 are fixed to the drive boxes 51 by means of shafts (not shown in the illustrations), which enable rapid disassembly and easy access to the interiors of the drive boxes 51 for maintenance. Behind the rear digging bar 42 are installed two conveyors, first a digging conveyor 43 and second a double-inclined conveyor 56, each separately driven by a hydraulic motor, such as the double-inclined bars conveyor motor 54, and chain transmission, digging conveyor transmission chain 45 (not shown in FIG. 4, shown in FIG. 6), and double-inclined conveyor bar transmission chain 59 (not shown in FIG. 4, shown in FIG. 5).

The hydraulic motors are operated by the tractor's hydraulic systems. The digging conveyor 43 is installed behind the rear digging bar 42 at an upward angle of 30 degrees relative to ground level. The rear conveyor is the double-inclined bar conveyor 56 which is installed behind the digging conveyor 43. The first part of the double-inclined bar conveyor 56 is at an upward angle of such as 30 degrees, which ends at a rear slope of such as 25 degrees, which continues until its end at a distance of approximately 35 cm from ground level. The double-inclined bar conveyor 56 serves to convey the plants to the rear and separate the dirt from them. The plants descend from the double-inclined bar conveyor 56 to the ground and are released from the peanut plant uprooter 100 in its motion forward. Behind the double-inclined bar conveyor 56 and from both of its sides are vertically installed two cylinders 60 on two parallelograms 70.

To facilitate distinction, one of the parallelograms 70 is shown in a separate circle in the upper right hand corner of the illustration, marked by the letter A.

The vacant space between the cylinders 60 is significantly smaller than the width of the peanut plant uprooter 100. The cylinders 60 are composed of tubes at a diameter of 60 cm, which are closed at their upper ends with a straight lid, which can be made of tin, and at their bottom ends with a concave bottom lid 62, (not shown in FIG. 4, shown in FIG. 6) which can also be made of tin. At the center of each cylinder, and for its entire length, is fixed a cylinder shaft 61, at whose top end two bearings are fixed.

The parallelograms 70 are constructed of beams, which can be made of square and hollow steel, with two of their front shafts 71 fixed to the chassis 95. Each cylinder 60 is connected by its bearings to its parallelogram 70 by means of a clutch 63. One side of the clutch 63 is connected to both bearings of the cylinder shaft 61, while its other side is connected at the center of each parallelogram rear beam 72. Each clutch 63 (not shown in FIG. 4, shown in FIG. 6), enables tuning the angle of the entire cylinder 60 relative to the vertical.

The parallelograms 70 enable the cylinders 60 to move upward and downward freely according to the ground level. When the peanut plant uprooter 100 is operated, the cylinders 60 are places upon the ground, upon the lower concave lids 62 and rotate around the cylinder shafts 61 in opposite directions to each other, during the forward movement of the peanut plant uprooter 100. In order to control the weight of the cylinders 60 on the ground, each parallelogram 70 is connected by its upper beams 73 to a closed hydraulic system 74 which includes an accumulator 75 connected to one end of a bidirectional hydraulic cylinder 76 while the other end is ventilated with a valve fixed to keep out dust. Gas pressure in the accumulator 75 determines the weight of the cylinders 60 to press on the ground. The hydraulic oil contained between the accumulator 75 and the bidirectional hydraulic cylinder 76 moves from the accumulator 75 to the bidirectional hydraulic cylinder 76 and back according to the direction of movement of the cylinder 60, upward or downward.

The internal volume of the accumulator 75 suffices to contain all of the oil that can be passed to the bidirectional hydraulic cylinder 76. The gas pressure within the accumulator 75 conforms to the dimensions of the bidirectional hydraulic cylinder 76 for the purpose of reducing pressure from the cylinder 60.

The plants descending from the peanut plant uprooter 100 pass through the relatively narrow gap d₁ between both cylinders 60, which are pressed and moved along the ground in a perpendicular direction to the direction of movement of the peanut plant uprooter 100, thus determining the width of the peanut windrows 32 (not shown in FIG. 4, shown in FIG. 3).

Underneath the peanut plant uprooter 100, where the double-inclined bar conveyor 56 reaches the apex of its height, is mounted a roller 48, which is built from a large diameter tube, which can be made of steel, with shaft running through its length. The shaft is connected to roller beams 49 by means of two bearings.

The roller 48 is connected to the chassis 95 from the front by means of two roller beams 49 and two shafts, and hangs from its rear to the chassis 95 by a hanging means 50, such as chains or cables. When the peanut plant uprooter 100 is operated, the roller 48 is placed upon the ground and is pulled by the uprooter 100 and is rotated by the ground during the uprooter 100 motion. In this state, the hanging means 50 in the rear is limp. When the peanut plant uprooter 100 is lifted by the tractor 20 (not shown in FIG. 4, shown in FIG. 2), the hanging means 50 are stretched, and suspend the roller 48 against its own weight. The roller 48 is designated to slightly compress the ground and flatten its surface before the peanut plants descend upon it.

In close proximity to the roller 48 and slightly behind it is one of the two support legs 97. These legs serve to support peanut plant uprooter 100, when necessary, for example, when in storage. In the configuration shown in the present illustration, the support legs 97 have two tuning holes 97a, one of which is visible in the present illustration, and which can be inserted with locking pin 97b, in order to fix the height of the legs for operation, or any other mode, such as storage apart from the tractor, as shown in the present illustration. During operation, the support legs 97 can be raised up or completely removed. In another configuration, the method of keeping the support legs 97 away from the ground can be by means of folding.

The illustration also shows the digging conveyor hydraulic motor 44, the active shaking mechanism motor 91, the double-inclined bars conveyor motion axle 55, and the double-inclined bars conveyor motor 54.

FIG. 5 is a right side view schematic illustration of a peanut plant uprooter 100, according to the present invention. The present illustration shows the right drive box 51 open, so as to show the front digging bar transmission chain 38. The illustration also shows the double-inclined bar conveyor transmission chain 59. The roller hanging means 50 shown in the present illustration is a chain.

FIG. 6 is a left side view schematic illustration of a peanut plant uprooter 100, according to the present invention. In this illustration, the left drive box 51 is open, so as to show the rear digging bars transmission chain 39. Above cylinder 60, the illustration shows the cylinder shaft 61 which is connected to clutch 63, which is mounted to parallelogram rear bar 72.

The circle in the illustration, on the peanut plant uprooter 100, marked by the letter B, shows a magnification in an additional circle underneath, a side view of an active shaking system 90.

The present illustration also shows lower concave lids 62.

FIG. 7 is an isometric view schematic illustration of chassis 95, of the peanut plant uprooter, according to the present invention.

Chassis 95 is composed of two walls, the chassis left wall 95l and the chassis right wall 95r, each built of two elongated polygons, which are at an angle to each other, effectively on one plane, and provides a suitable shape to contain the digging conveyor 43 and the double-inclined bar conveyor 56. Both walls are connected to each other by means of several lateral beams 95b.

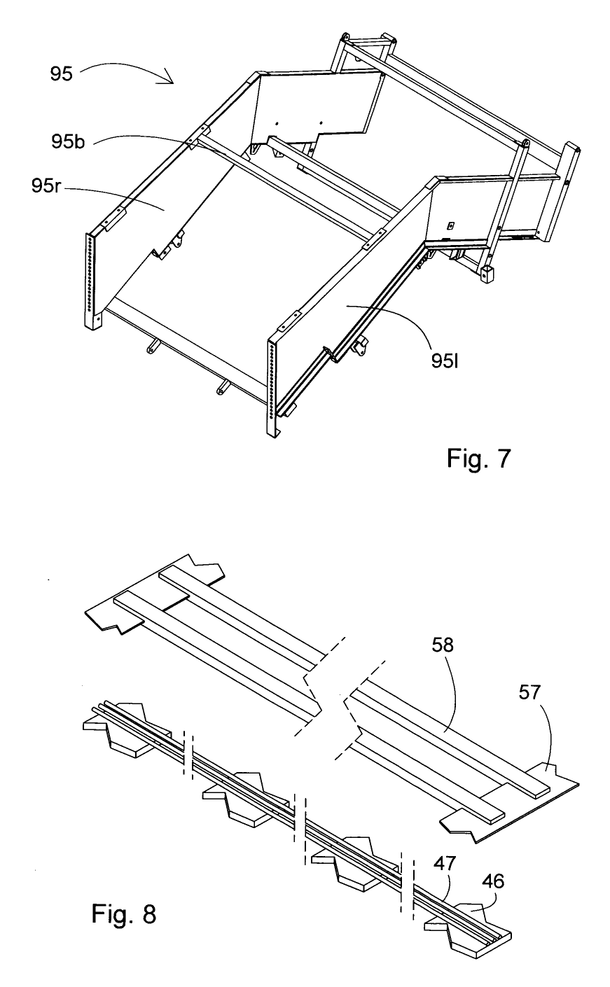

FIG. 8 is an isometric view schematic illustration of conveyor bars of the peanut plant uprooter, according to the present invention. The top part of the present illustration shows two adjacent double-inclined conveyor bars 58, which are connected at their ends to double-inclined bar conveyor band 57. Their cross sections, in the configuration shown in the present illustration, are rectangular. Due to the scale of the illustration, the bars are sectioned at their centers, and the bands are also sectioned.

The double-inclined bar conveyor 56 (not shown in FIG. 8, shown in FIG. 5), is made of double-inclined conveyor bars 58, which can be made of steel, and be hollow, with a quadrangular cross section of 5×3 cm, with the vacant space between every two bars being 11 cm. The double-inclined conveyor bars 58 have no cleats (which are prevalent in prior art peanut plant uprooter machines), thus eliminating the need to separate the peanuts from the double-inclined bar conveyor 56 (not shown in FIG. 8, shown in FIG. 5). The ends of the bars of the double-inclined bar conveyor 56 are connected to two double-inclined bar conveyor bands 57, which are serrated drive bands which can be made of fortified rubber. The dimensions of the double-inclined conveyor bars 58 and the gaps between them were determined to enable carrying the plants without any sinking and easily releasing them to the ground without pulling off any peanuts, and also to sift dirt.

The bottom part of the illustration shows three adjacent digging conveyor bars 47, which are connected to four digging conveyor bands 46. Their cross sections, in the configuration shown in the present illustration are circular. Due to the scale of the illustration, the bars are sectioned, and the bands are sectioned as well.

In the present example, which is as noted, not in any way limiting the present invention, the digging conveyor bars 47, which can be made of steel with circular cross sections of a diameter of 7 mm, with the vacant gaps between every two bars being 7 mm. The digging conveyor bars 47 are laterally connected to four digging conveyor bands 46, which can be made of fortified rubber or any other suitable material, two at the ends and two at the center, at even lateral intervals. The digging conveyor 43 penetrates the ground underneath the peanuts and lifts the plants with a layer of soil. The small diameter of the digging conveyor bars 47 minimizes the resistance of the ground to the penetration, and the small gaps between them prevent peanuts from falling through the conveyor.

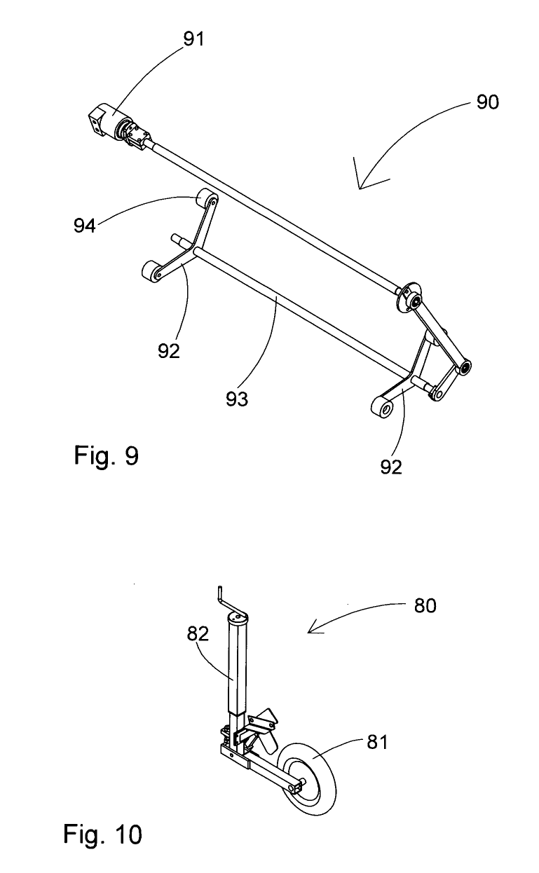

FIG. 9 is an isometric view schematic illustration of an active shaking system 90, of the peanut plant uprooter, according to the present invention.

Underneath the upward moving upper side of the double-inclined conveyor bars 56 (not shown in FIG. 8, shown in FIG. 5), is installed an active shaking system 90, which is constructed from two active shaking mechanism arms 92 connected to a active shaking mechanism shaft 93, at whose ends are installed an active shaking mechanism wheel 94 upon which the double-inclined bar conveyor 56 (not shown in FIG. 8, shown in FIG. 5), rests or moves. The shaft 93 is driven back and forth by active shaking mechanism motor 91, at tuneable frequencies. The active shaking mechanism motor 91, which can be a hydraulic motor, is driven by the tractor's hydraulic system. The active shaking system 90 is meant to vibrate the double-inclined bar conveyor 56 (not shown in FIG. 8, shown in FIG. 5), and release dirt clumps and clods from the plants.

Activation of the active shaking system 90 by a hydraulic motor enables adapting the shaking frequency to the type of soil and the ripeness of the peanuts. For example, in sandy soil, and for particularly ripe peanuts, a lower shaking frequency would be more suitable relative to that which is suitable for heavy soil and younger peanuts. The selection of shaking frequency can be determined through trial and error.

FIG. 10 is an isometric view schematic illustration of a depth control system 80, of the peanut plant uprooter, according to the present invention.

The peanut plant uprooter is equipped with a depth control system 80 for the purpose of controlling the working depth, namely the digging depth. The depth control system can be a system of a model or manufacturer such as the ones presently in use in mowers and onion harvesters.

The depth control system 80 in the present example also includes a screw jack 82, a hydraulic system, and an electric control box. The screw jack 82 is installed on the machine chassis from the inside, while the bottom part of the screw jack 82 is fixed with an arm on a shaft. At the end of the arm is an axle, which is mounted with a depth control system wheel 81. The arm shaft on the side of the screw jack 82 is connected to an additional arm, upon which is disposed a shaped piece of tin, which is connected to it by means of screws. When the screws are released, the tin is able to move freely along the arm. An additional arm is rigidly connected to the screw jack 82, upon which are fixed at an interval two magnetic proximity probes, one after the other, with one of the probes installed slightly higher than the other relative to ground level. The depth control hydraulic system includes an electric direction control valve, which is connected by means of hydraulic pipes to lifting arm cylinder of the tractor, to the pressure line, and to the return line of the tractor's hydraulic system. The control box is fed with fixed voltage from the tractor, and is connected to the proximity probes and the electromagnets of the direction control valve.

When the peanut plant uprooter is operated, the depth control system wheel 81 tracks the ground level and accordingly moves the arm with the shaped piece of tin up and down. When the tin blocks one of the probes, the hydraulic valve is operated, and the peanut plant uprooter is elevated or lowered accordingly. The screw jack 82 serves to tune the depth of the peanut plant uprooter in the ground. This tuning is usually adjusted just prior to operation, and the arm with the shaped piece of tin serves to adjust the range of response to changes. The system is designate to control the depth of the frontal digging bar 41 (not shown in FIG. 10, shown in FIG. 4) and the rear digging bar 42 (not shown in FIG. 10, shown in FIG. 4), within the ground. The need for depth control arises from the lack of uniformity between the ditches in which the tractors wheels track and the ground level of the peanut beds.

The structure of the peanut plant uprooter ensures that if there is any soil left on the double-inclined bar conveyor 56 (not shown in FIG. 10, shown in FIG. 5), at the end of its path, it returns to the ground, underneath the uprooted plants after their descent from the machine, without any soil covering the plants. The double-inclined bar conveyor 56 (not shown in FIG. 10, shown in FIG. 5), conveys the layer of plants from the bottom, and places it on the ground in the same orientation as it was originally.

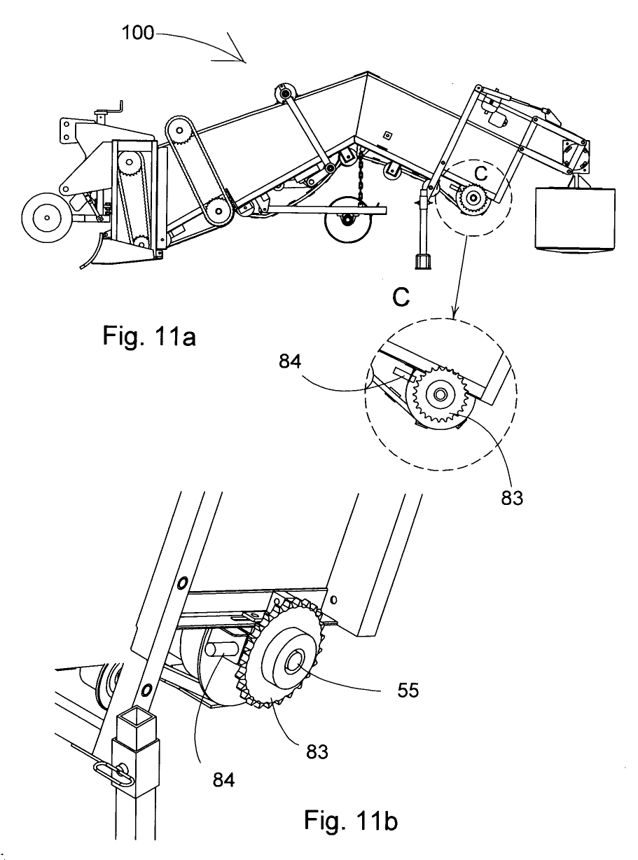

FIG. 11a is a left side view schematic illustration of a peanut plant uprooter 100, equipped with a cog wheel 83 and a revolutions gauge 84, according to an embodiment of the present invention.

The circle in the illustration, on the peanut plant uprooter 100, marked by the letter C, shows a magnification, in an additional circle underneath, of the cog-wheel 83 and the revolutions gauge 84.

FIG. 11b is an isometric view schematic illustration of a cog-wheel 83, and a revolutions gauge 84, according to an embodiment of the present invention.

According to one embodiment of the present invention, the digging conveyor 43, and the double-inclined bars conveyor 56 are driven by hydraulic motors, such that their velocity during activation could be adjusted relative to the velocity of the tractor. This parameter is particularly important for the purpose of successful uprooting with low loss. For this purpose, the double-inclined bars conveyor motion axle 55, a cog wheel 83 faced by a revolutions gauge 84, which can be a magnetic proximity probe are used.

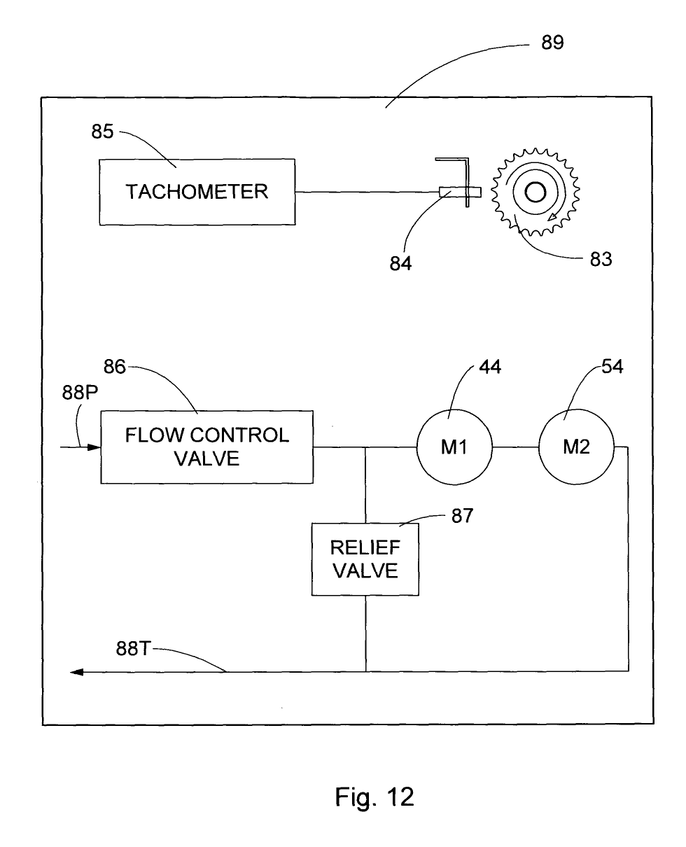

FIG. 12 is a schematic view of a conveyors speed control loop 89, according to the present invention.

The tractor operator's chamber is equipped with a tachometer 85, which can be a calibrated digital speedometer which gives the operator a display of the motion velocity of the double-inclined bars conveyor relative to the chassis. The adjustment of velocity of the conveyors to that of the tractor relative to the ground is done by opening or closing a hydraulic supply valve of the tractor's hydraulic system. This can be done manually, by the tractor operator, or automatically. Note that the operator's instructions are to activate the double-inclined bars conveyor at a higher velocity than that of movement relative to the ground, for example, by a rate of approximately 10%, due to the inclination of the conveyors relative to the ground surface.

The digging conveyor hydraulic motor 44 and the double-inclined bars conveyor motor 54 are hydraulically serially connected, so that any change in the supply of hydraulic oil affects both.

The hydraulic oil is supplied to the digging conveyor hydraulic motor 44 and the double-inclined bars conveyor motor 54 from a hydraulic pressure line 88P, is controlled by a flow control valve 86, and flows back through a hydraulic return line 88T. A relief valve 87 is installed between the hydraulic pressure line 88P and the hydraulic return line 88T.

The digging conveyor hydraulic motor 44 and the double-inclined bars conveyor motor 54, as well as other components, can be selected such that the linear velocity of the digging conveyor and the double-inclined bars conveyor will be practically identical.

While the invention has been described with respect to a limited number of embodiments, it should be appreciated that many variations, modifications and other applications of the invention may be made.

What is claimed is:

1. A peanut plant uprooter (100), for uprooting peanut plants, comprising:
(a) a chassis (95);
(b) a frontal digging bar (41) positioned on said chassis (95);
(c) a rear digging bar (42) positioned on said chassis (95) behind said frontal digging bar (41);
(d) a digging conveyor (43) positioned on said chassis (95) behind said rear digging bar (42);
(e) a double-inclined bars conveyor (56) positioned on said chassis (95) behind said digging conveyor (43);
(f) two parallelograms (70) positioned on the rear part of said chassis (95); and
(g) two cylinders (60) positioned below said two parallelograms (70), each one of said cylinders (60) below a different one of said parallelograms (70).

2. The peanut plant uprooter (100) of claim 1 further comprising:
(h) a frontal digging bar transmission chain (38), operatively connected to said digging conveyor (43), for transmitting a rotational movement from a tractor's propulsion mechanism to said digging conveyor (43);
(i) a double-inclined bars conveyor motor (54); and
(j) a double-inclined bar conveyor transmission chain (59), operatively connected to said double-inclined bars conveyor motor (54), and to said double-inclined bars conveyor (56), for rotating said double-inclined bars conveyor (56), wherein said double-inclined bars conveyor (56) includes:
(i) at least two double-inclined bar conveyor bands (57); and
(ii) double-inclined conveyor bars (58), wherein each of said double-inclined conveyor bars (58) is connected to at least two of said double-inclined bar conveyor bands (57).

3. The peanut plant uprooter (100) of claim 2 wherein said digging conveyor (43) includes:
(i) at least two digging conveyor bands (46); and
(ii) digging conveyor bars (47), wherein each one of said conveyor bars (47) is connected to at least two of said digging conveyor bands (46).

4. The peanut plant uprooter (100) of claim 3 wherein said chassis (95) includes:
(i) a chassis left wall (95r);
(ii) a chassis right wall (95l); and
(iii) at least one lateral beam (95b) connected to said chassis left wall (95r) and to said chassis right wall (95r).

5. The peanut plant uprooter (100) of claim 1 further comprising:
(h) an active shaking mechanism (90) for actively vibrating said double-inclined bar conveyor (56), wherein said active shaking mechanism (90) is connected to said chassis (95).

6. The peanut plant uprooter (100) of claim 5 wherein said active shaking mechanism (90) includes:
(i) an active shaking mechanism shaft (93);
(ii) at least one active shaking mechanism arm (92), connected to said active shaking mechanism shaft (93);
(iii) at least one active shaking mechanism wheel (94), installed on said at least one active shaking mechanism arm (92); and
(iv) an active shaking mechanism motor (91), wherein said active shaking mechanism motor (91) is operatively connected to said chassis (95).

7. The peanut plant uprooter (100) of claim 1 further comprising:
(h) two drive boxes (51) attached on a front side of said chassis (95);
(i) two shoes (52), each one being disposed on one of said drive boxes (51); and
(j) two tilling chisels (53), each one being disposed on one of said shoes (52).

8. The peanut plant uprooter (100) of claim 1 further comprising:
(h) a depth control system (80) for controlling digging depth, wherein said depth control system is positioned in a front side of said peanut plant uprooter (100).

9. The peanut plant uprooter (100) of claim 8 wherein said depth control system (80) includes:
(i) a depth control system wheel (81); and
(ii) a screw jack (82) operatively connected to said depth control system wheel.

10. The peanut plant uprooter (100) of claim 1 wherein during operation of uprooting peanut plants, said peanut plant uprooter (100) is harnessed to a tractor, wherein each one of said double-inclined conveyor bars (58) moves in a cyclic motion, wherein in part of said cyclic motion said each one of said double-inclined conveyor bars (58) moves backward relative to said chassis (95) in an upward angle relative to the ground and after that in a downward angle relative to the ground at a predetermined speed relative to the ground.

11. The peanut plant uprooter (100) of claim 10, wherein said predetermined speed relative to the ground, is at least one percent faster and at most ten percent slower than said tractor's speed.

12. The peanut plant uprooter (100) of claim 1 further comprising:
(h) two roller beams (49) operatively connected to a bottom side of said peanut plant uprooter (100); and
(i) a roller (48) mounted between said two roller beams (49), for slightly compressing the ground and flatten its surface before peanut plants descend upon it.

13. The peanut plant uprooter (100) of claim 1 further comprising:
(h) at least one support leg (97) for supporting said peanut plant uprooter (100) when said peanut plant uprooter (100) is in a storage state, said at least one support leg (97) being mounted to a bottom side of said peanut plant uprooter (100).

14. The peanut plant uprooter (100) of claim 1 further comprising:
(h) a digging conveyor hydraulic motor (44) for propulsion of said digging conveyor (43), said digging conveyor hydraulic motor (44) is disposed on said chassis (95); and
(i) a digging conveyor transmission chain (45) operatively connected to said digging conveyor hydraulic motor (44) and to said digging conveyor (43).

15. The peanut plant uprooter (100) of claim 14 further comprising:
(j) a double-inclined bars conveyor motor (54) for propulsion of said double-inclined bars conveyor (56), said double-inclined bars conveyor motor (54) being disposed on said chassis (95);
(k) a cog-wheel (83);
(I) a revolutions gauge (84); and
(m) a tachometer (85),
wherein said cog-wheel (83), and said revolutions gauge (84) are positioned on said chassis (95) for measuring motion speed of said double-inclined conveyor bars (58), and wherein said tachometer (85) is mounted in a tractor cabin for displaying a speed of said conveyor bars (58) to an operator.

16. The peanut plant uprooter (100) of claim 15 further comprising:
(n) a flow control valve (86) operatively connected to said digging conveyor hydraulic motor (44);
(o) a hydraulic pressure line (88P), operatively connected to said flow control valve (86);
(p) a hydraulic return line (88T), operatively connected to said double-inclined bars conveyor motor (54); and
(q) a relief valve (87), operatively connected between said hydraulic pressure line (88P) and said hydraulic return line (88T).

17. The peanut plant uprooter (100) of claim 1 further comprising:
(h) a closed hydraulic system (74) for controlling forces that said cylinders (60) applies on the ground, wherein said closed hydraulic system (74) includes:
(i) an accumulator (75); and
(ii) two bidirectional hydraulic cylinders (76), operatively connected to said umulatoracc (75), wherein each one of said two parallelograms (70) includes:
(i) a parallelogram upper beam (73); and
(ii) a parallelogram rear beam (72); operatively connected to said parallelogram upper beam (73), wherein each one of said cylinders (60) is mounted to different one of said two parallelograms (70), and wherein each one of said two bidirectional hydraulic cylinder (76), is operatively connected to a different one of said two parallelograms (70).

18. The peanut plant uprooter (100) of claim 2 wherein said peanut plant uprooter (100) includes no conveyors cleat, and wherein said peanut plant uprooter (100) includes no pulling assembly for pulling peanut plant from said peanut plant uprooter (100).

19. The peanut plant uprooter (100) of claim 1 further comprising:
(h) a frontal digging bar transmission chain (38), operatively connected to said digging conveyor (43), for transmitting rotational movement from a tractor's propulsion mechanism to said digging conveyor (43);
(i) a double-inclined bars conveyor motor (54);
(j) a double-inclined bar conveyor transmission chain (59), operatively connected to said double-inclined bars conveyor motor (54), and to said double-inclined bars conveyor (56), for rotating said double-inclined bars conveyor (56), wherein said double-inclined bars conveyor (56) includes:
(i) at least two double-inclined bar conveyor bands (57); and
(ii) double-inclined conveyor bars (58), wherein each one of said double-inclined conveyor bars (58) is connected to at least two of said double-inclined bar conveyor bands (57), wherein said digging conveyor (43) includes:
(i) at least two digging conveyor bands (46); and
(ii) digging conveyor bars (47), wherein each one of said conveyor bars (47) is connected to at least two of said digging conveyor bands (46), wherein said chassis (95) includes:
(i) a chassis left wall (95r);
(ii) a chassis right wall (95l); and
(iii) at least one lateral beam (95b) connected to said chassis left wall (95r) and to said chassis right wall (95r);
(k) an active shaking mechanism (90) for vibrating said double-inclined bar conveyor (56), connected to said chassis (95), wherein said active shaking mechanism (90) includes:
(i) an active shaking mechanism shaft (93);
(ii) at least one active shaking mechanism arm (92), connected to said active shaking mechanism shaft (93);
(iii) at least one active shaking mechanism wheel (94), installed on said at least one active shaking mechanism arm (92); and
(iv) an active shaking mechanism motor (91), wherein said active shaking mechanism motor (90) is operatively connected to said chassis (95);
(l) two drive boxes (51) attached on a front side of said chassis (95);
(m) two shoes (52) wherein each one of said two shoes (52) is disposed on different one of said drive boxes (51);
(n) two tilling chisels (53) each one is disposed on different one of said shoes (52);
(o) a depth control system (80) for controlling a digging depth, wherein said depth control system is positioned on a front side of said peanut plant uprooter (100), wherein said depth control system (80) includes:
(i) a depth control system wheel (81); and
(ii) a screw jack (82) operatively connected to said depth control system wheel;
(p) two roller beams (49) operatively connected to a bottom side of said chassis (95);
(q) a roller (48) mounted between said two roller beams (49), for slightly compressing the ground and flatten its surface before peanut plants descend upon it;
(r) at least one support leg (97) for supporting said peanut plant uprooter (100) when said peanut plant uprooter (100) is in a storage state, said at least one support leg (97) is mounted to a bottom side of said peanut plant uprooter (100);
(s) a digging conveyor hydraulic motor (44) for propulsion of said digging conveyor (43), said digging conveyor hydraulic motor (44) is disposed on said chassis (95);
(t) a digging conveyor transmission chain (45) operatively connected to said digging conveyor hydraulic motor (44) and to said digging conveyor (43);
(u) a cog-wheel (83);
(v) a revolutions gauge (84);
(x) a tachometer (85),
wherein said cog-wheel (83), and said revolutions gauge (84) are positioned on said chassis (95) for measuring a speed motion of said double-inclined conveyor bars (58), wherein said tachometer (85) is mounted in a tractor cabin for displaying a speed of said conveyor bars (58) to an operator;
(y) a flow control valve (86) operatively connected to said digging conveyor hydraulic motor (44) and to the double-inclined bars conveyor motor (54) with a relief valve (87) for a conveyors speed control; and
(z) a closed hydraulic system (74) for controlling forces that said cylinders (60) applies on the ground, wherein said closed hydraulic system (74) includes:
(i) an accumulator (75); and
(ii) two bidirectional hydraulic cylinders (76), operatively connected to said accumulator (75), wherein each one of said two parallelograms (70) includes:
(i) a parallelogram upper beam (73); and
(ii) a parallelogram rear beam (72), operatively connected to said parallelogram upper beam (73), wherein each one of said cylinders (60) is mounted to a different one of said two parallelograms (70), and wherein each one of said two bidirectional hydraulic cylinder (76), is operatively connected to a different one of said two parallelograms (70), wherein in operation of peanut plant uprooting, said peanut plant uprooter (100) is harnessed to a tractor, wherein each one of said double-inclined conveyor bars (58), is moving in a cyclic motion, wherein in part of said cyclic motion said each one of said double-inclined conveyor bars (58) is moving backward relative to said ischass (95) in an upward angle relative to the ground and after that in a downward angle relative to the ground at a predetermined speed relative to the ground.

20. A method for peanut plant uprooting comprising the stages of:
(a) driving a peanut plant uprooter (100), by a tractor, over a peanut field, wherein said peanut plant uprooter (100) includes:
(i) a chassis (95);
(ii) a frontal digging bar (41) positioned on said chassis (95);
(iii) a rear digging bar (42) positioned on said chassis (95) behind said frontal digging bar (41);
(iv) a digging conveyor (43) positioned on said chassis (95) behind said rear digging bar (42);
(v) a double-inclined bars conveyor (56) positioned on said chassis (95) behind said digging conveyor (43);
(vi) two parallelograms (70) positioned on a rear part of said chassis (95); and
(vii) two cylinders (60) positioned below said two parallelograms (70), each one of said cylinders (60) being below a different one of said parallelograms (70);
(vii) a frontal digging bar transmission chain (38), operatively connected to said digging conveyor (43), for transmitting a rotational movement from a tractor's propulsion mechanism to said digging conveyor (43);
(viii) a double-inclined bars conveyor motor (54);
(ix) a double-inclined bar conveyor transmission chain (59), operatively connected to said double-inclined bars conveyor motor (54), and to said double-inclined bars conveyor (56), wherein said digging conveyor (43) includes:
(ixa) at least two digging conveyor band (46); and
(ixb) digging conveyor bars (47), wherein each of said conveyor bars (47) is connected to at least two of said digging conveyor band (46);
(x) an active shaking mechanism (90) for vibrating said double-inclined bar conveyor (56), connected to said chassis (95);
(xi) a depth control system (80) for controlling a digging depth, wherein said depth control system is positioned in a front side of said peanut plant uprooter (100); and
(xii) a roller (48) operatively connected to a bottom side of said peanut plant uprooter (100);
(b) inserting said frontal digging bar (41) and said rear digging bar (42)_into the ground;
(c) controlling depth, by said depth control system (80), one of said digging conveyor bars (47), of said digging conveyor (43), which is at a time the lowest among said digging conveyor bars (47) at a predetermined depth inside the ground;
(d) conveying peanut plants on said double-inclined bars conveyor (56) and shaking said double-inclined bars conveyor (56) by an active shaking mechanism (90);
(e) compressing the ground and flattening its surface, by said roller (48);
(f) lowering the peanut plants behind said peanut plant uprooter (100) onto the ground at an orientation wherein the peanut plants leafs are above the peanut plants pods; and
(g) arranging, by said rotating cylinders (60), the lowered peanut plants on the ground in a windrow with a predetermined width.
